(19) United States
(12) Patent Application Publication
(10) Pub. No.: US 2026/0077488 A1
(43) Pub. Date: Mar. 19, 2026

(54) APPARATUS FOR COLLECTING ROBOT TRAINING DATA

(71) Applicant: Toyota Research Institute, Inc., Los Altos, CA (US)

(72) Inventor: Richard Denitto, Watertown, MA (US)

(73) Assignees: Toyota Research Institute, Inc., Los Altos, CA (US); Toyota Jidosha Kabushiki Kaisha, Aichi-ken (JP)

(21) Appl. No.: 18/955,343

(22) Filed: Nov. 21, 2024

Related U.S. Application Data
(60) Provisional application No. 63/694,483, filed on Sep. 13, 2024.

(51) Int. Cl. B25J 9/16; B25J 15/00; B25J 15/06; B25J 19/02

(52) U.S. Cl. CPC B25J 9/163; B25J 15/0019; B25J 15/0608; B25J 19/023

(57) ABSTRACT

An apparatus for collecting robot training data includes an end effector. The apparatus includes a camera supported by the end effector. The apparatus includes a mirror movable from a first position that is attached to the end effector to a second position that is detached from the end effector. The mirror in the first position is magnetically coupled to the end effector and oriented such that light reflected by the mirror is directed toward the camera.

### CROSS-REFERENCE TO RELATED APPLICATION

This application claims priority to and all benefits of U.S. Provisional Application No. 63/694,483, filed September 13, 2024, for “Universal Manipulation Interface,” which is hereby incorporated by reference in its entirety including the drawings.

### TECHNICAL FIELD

The present specification generally relates to an apparatus and method for collecting robot training data and, more specifically, to a handheld end effector apparatus for collecting video data to train a robot to perform certain tasks.

### BACKGROUND

Sensorized handheld end effectors may be used as a data collection interface for collecting robot training data. For example, image data collected by a camera of a handheld end effector may be used to develop a protocol for robot operation. Using sensorized handheld end effectors as data collection interfaces for collecting robot training data has required the use of specialized apparatuses that are susceptible to certain types of damage, e.g., when dropped by a user.

Accordingly, a need exists for alternative handheld end effector apparatus for collecting video data to train a robot to perform certain tasks.

### SUMMARY

In one embodiment, an apparatus for collecting robot training data may include an end effector. The apparatus may include a camera supported by the end effector. The apparatus may include a mirror movable from a first position that is attached to the end effector to a second position that is detached from the end effector. The mirror in the first position may be magnetically coupled to the end effector and oriented such that light reflected by the mirror is directed toward the camera.

A method for collecting robot training data includes providing an apparatus having an end effector and a camera. The method includes providing a mirror. The method includes attaching the mirror to the apparatus via magnetic coupling. The method includes performing a task with the apparatus while collecting data with the camera.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of an apparatus having an end effector in an open position and a camera for collecting data to program a robot using machine learning according to one or more embodiments shown and described herein;

FIG. 2 depicts a top view of a portion of the apparatus having the end effector in a closed position according to one or more embodiments shown and described herein;

FIG. 3 depicts a perspective of the apparatus with a mirror and magnets exploded according to one or more embodiments shown and described herein;

FIG. 4 depicts a cross-section view of a portion of the apparatus with a mirror in a first position that is attached to the end effector according to one or more embodiments shown and described herein;

FIG. 5 depicts a perspective of the apparatus with first and second mirrors in second positions that are in a second position detached from the end effector according to one or more embodiments shown and described herein; and

FIG. 6 depicts a flow chart illustrating a method for collecting robot training data with the apparatus according to one or more embodiments shown and described herein.

### DETAILED DESCRIPTION

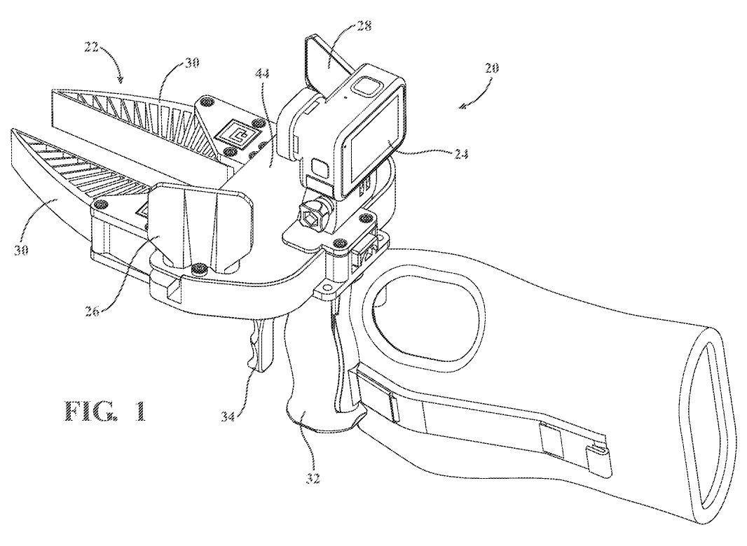

FIG. 1 generally depicts an apparatus 20 for collecting robot training data. The apparatus 20 includes an end effector 22 and a camera 24 supported by the end effector 22. Image data collected by the camera 24 may be used to develop protocols for controlling a robot to perform certain tasks, e.g., using machine learning with images collected by the camera 24 while manually manipulating the apparatus 20 to perform a certain task. The apparatus 20 also includes one or more mirrors 26, 28 that may reflect light toward the camera 24, i.e., to shape a field-of-view FOV of the camera 24. The mirrors 26, 28 are each movable from a first position that is attached to the end effector 22 to a second position that is detached from the end effector 22. The mirrors 26, 28 in the first position are magnetically coupled to the end effector 22 and oriented such that light reflected by the mirrors 26, 28 is directed toward the camera 24. Magnetically coupling the mirrors 26, 28 to the end effector 22 enables the mirrors 26, 28 to detach without damaging apparatus 20, e.g., when an operator accidently drops the end effector 22. After detaching, the mirrors 26, 28 can be easily reattached to the end effector 22 via magnetic coupling.

The end effector 22 is configured to be operable by a user, e.g., by hand, and generally replicates a robot end effector. The image data captured by the camera 24 of the end effector 22 may be similar to image data captured by a camera of the robot, e.g., when performing a certain task. Example tasks include, for example, folding clothes, washing dishes, preparing food, and other object manipulation based tasks. The image data captured by the camera 24 of the end effector 22 may be used to train the robot to perform the certain task, e.g., using machine learning that utilizes the image data captured by the camera 24 of the end effector 22 as a guide for the robot to perform the certain task. When performing the certain task, the robot is controlled such that the image data captured by the camera of the robot conforms to the image data captured by the camera 24 of the end effector 22.

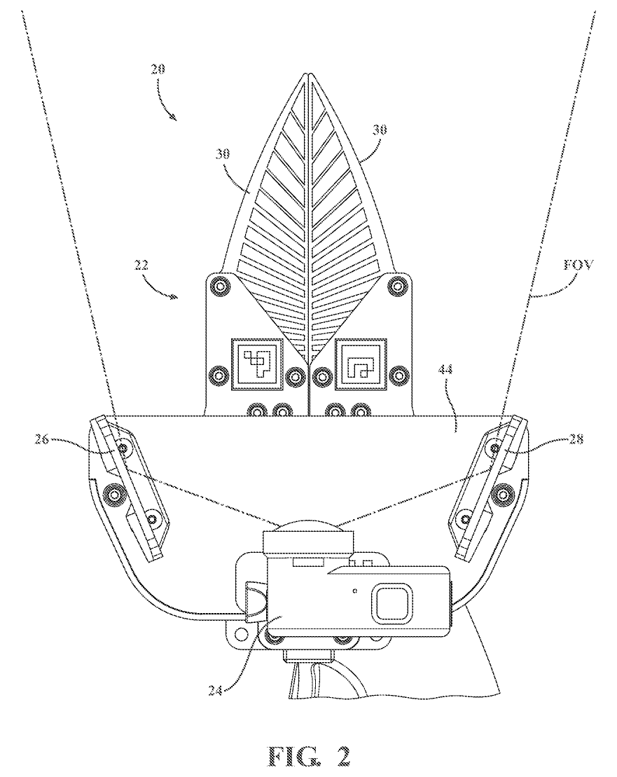

The end effector 22 may be a gripper type end effector including one or more fingers 30 movable from an open positon, shown in FIG. 1, to a closed position, shown in FIG. 2, and vice versa. The fingers 30 may be movable between the open position and the closed position continuously and/or step wise. In other words, the fingers 30 may be movable to numerous positions between the open position and the closed position. The example end effector 22 provided in the FIGS. includes two fingers 30, however, it is to be understood that the end effector 22 may include other numbers of fingers 30, e.g., three, four, etc. Additionally or alternately to the fingers 30, the gripper 22 may include other end effector structures, e.g., vacuum end effectors, magnetic end effectors, brushes, utensils, machining tools, etc.

The end effector 22 may include a handle 32 with a trigger 34 configured to actuate the fingers 30 from the open position to the closed position. The handle 32 provides a structure for the operator to grasp and manipulate movement of the end effector 22. The trigger 34 may be mechanically linked to the fingers 30 such that moving the trigger 34 toward the handle 32, e.g., by the operator, moves the fingers 30 toward the closed position. A spring may be included to urge the trigger 34 away from the handle 32 and the fingers 30 toward the open position, e.g., moving the fingers 30 to the open position when the trigger 34 is released. Additional or alternative structure may be included to actuate the fingers 30 in response to a user input to the trigger 34, e.g., a switch, a sensor, a servo, etc.

The camera 24 detects light and generates image data based on the detected light. The camera 24 includes an image sensor that turns light into discrete signals. For example, the camera 24 may include a charge-coupled device (CCD) or a complementary metal–oxide–semiconductor (CMOS) based image sensor. The camera 24 may include one or more lenses, mirrors and/or other optical structures that focus light on the image sensor.

The camera 24 is supported by the end effector 22. In other words, weight of the camera 24 is borne by the end effector 22. For example, the camera 24 may be fixed to the end effector 22 with adhesive, a fastener, or other suitable structure. The camera 24 may be fixed to a top surface 44 of the end effector 22, e.g., opposite the handle 32 extending at a bottom of the end effector 22. The camera 24 may be oriented toward the fingers 30, i.e., such that the fingers 30 are in the field-of-view FOV of the camera 24. The example apparatus 20 provided in the FIGS. includes one camera 24, however, it is to be understood that the apparatus 20 may include other numbers of cameras 24, e.g., two, three, four, etc.

One or more mirrors 26, 28 may be included to shape the field-of-view FOV of the camera 24, e.g., when the mirrors 26, 28 are at the first positions. The mirrors 26, 28 at the first positions are oriented such that light reflected by the mirrors 26, 28 is directed toward the camera 24, as shown in FIG. 2. In the example apparatus 20, a pair of mirrors 26, 28 are included. The pair of mirrors 26, 28 at the first positions are orientated to provide stereoscopic views to the camera 24. The stereoscopic views may enable image data captured by the camera 24 to indicate positions of objects in the data in three dimensional space. In other words, the mirrors 26, 28 may be configured to provide binocular stereopsis. For example, the mirrors 26, 28 may direct outward portions of the field-of-view FOV, e.g., right and left portions of the field-of-view FOV, toward a centerline of the field-of-view FOV and toward the fingers 30. The example shown in the FIGS. includes two mirrors 26, 28, however, it is to be understood that a lesser or greater number of mirrors 26, 28 may be included, e.g., one, three, four, etc.

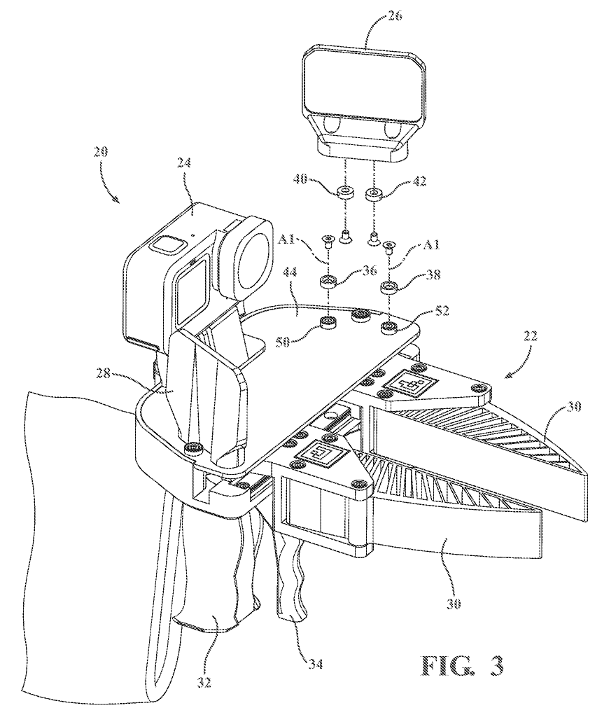

Referring to FIG. 3, the mirrors 26, 28 in the first positions are magnetically coupled to the end effector 22. In other words, magnetic forces secure the mirrors 26, 28 at the first positions to the end effector 22. One or more magnets 36, 38 may be fixed to the end effector 22 and one or more magnets 40, 42 may be fixed to the mirrors 26, 28, e.g., via fastener, adhesive or other suitable structure. The magnets 36, 38, 40, 42 generate a magnetic field. For example, the magnets 36, 38, 40, 42 may be neodymium or other permanent magnet material. In the first positions, the magnets 36, 38 fixed to the end effector 22 may be magnetically coupled with the magnets 40, 42 fixed to the mirrors 26, 28. Additionally or alternately, the magnets 36, 38 fixed to the end effector 22 may magnetically couple with ferromagnetic material of the mirrors 26, 28 and/or the magnets 40, 42 fixed to the mirrors 26, 28 may magnetically couple with ferromagnetic material of the end effector 22.

The magnets 36, 38 fixed to the end effector 22 may be spaced from each other along the top surface 44 of the end effector 22. For example, a first pair of magnets 36 may be fixed to the end effector 22 and may magnetically couple the first of the mirrors 26 in the first position and a second pair of magnets 38 may be fixed to the end effector 22 and may magnetically couple the second of the mirrors 28 in the first position. The magnets 36 of the first pair may be spaced from each other along the top surface 44 of the end effector 22 and the magnets 38 of the second pair may be spaced from each other along the top surface 44 of the end effector 22. Spacing the magnets 36, 38 of each pair from each other along the top surface 44 of the end effector 22 may maintain the mirrors 26, 28 in certain orientations at the first positions, e.g., to direct light toward the camera 24.

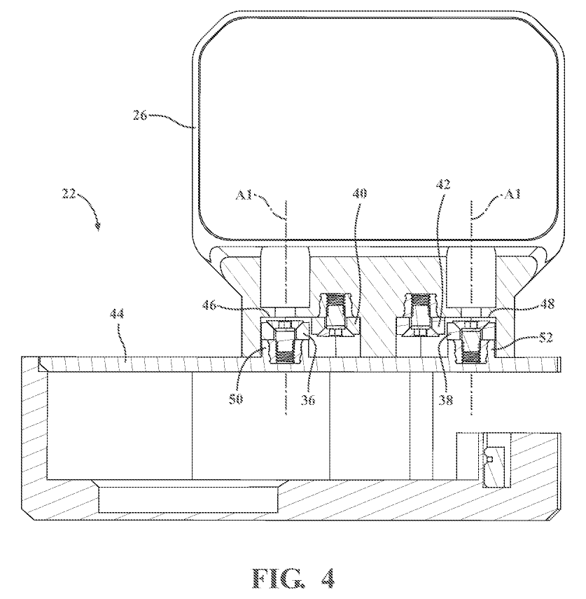

The end effector 22 and/or the mirrors 26, 28 may include additional or alternate structure to align the mirrors 26, 28 at the first positions relative to the end effector 22 and the camera 24 attached thereto. For example, referring to FIG. 4, each of the mirrors 26, 28 may include a recess 46, 48, e.g., extending upward from a bottom surface of the respective mirror 26, and the end effector 22 may include one or more protrusions 50, 52, e.g., each extending upward from the top surface 44 of the end effector 22 along a respective axis A1. First and second protrusions 50, 52 may be disposed in the recess 46, 48 of each mirror 26 in the first position, e.g., inhibiting translational and/or rotational movement of the mirrors 26, 28 along the top surface 44 of the end effector 22. In other words, first and second protrusions 50, 52 may be disposed in the recess 46 of one mirror 26 the first position, and first and second protrusions 50, 52 may disposed in the recess 48 of the other mirror 28 the first position.

The magnets 36, 38, 40, 42 may be disposed in the recesses 46, 48 when the mirrors 26, 28 are in the first positions. For example, the magnets 36, 38 fixed to the end effector 22 and the magnets 40, 42 fixed to the mirrors 26, 28 may be disposed in the recesses 46, 48 when the mirrors 26, 28 are in the first positions. The magnets 36, 38 fixed to the end effector 22 may be fixed at distal ends of the protrusions 50, 52, e.g., spaced from the top surface 44 along the axis A1 of each protrusion 50, 52. The magnets 40, 42 fixed to the mirrors 26, 28 may be radially spaced from the magnetically coupled magnets 36, 38 fixed to the end effector 22 relative to the axis A1 of the respective protrusion 50, 52. For example, the magnet 36 fixed to the end effector 22 may be spaced from the magnet 40 fixed to the mirror 26 perpendicular to the axis A1 within one recess 46, and the magnet 38 fixed to the end effector 22 may be spaced from the magnet 42 fixed to the mirror 26 perpendicular to the axis A1 within the other recess 48.

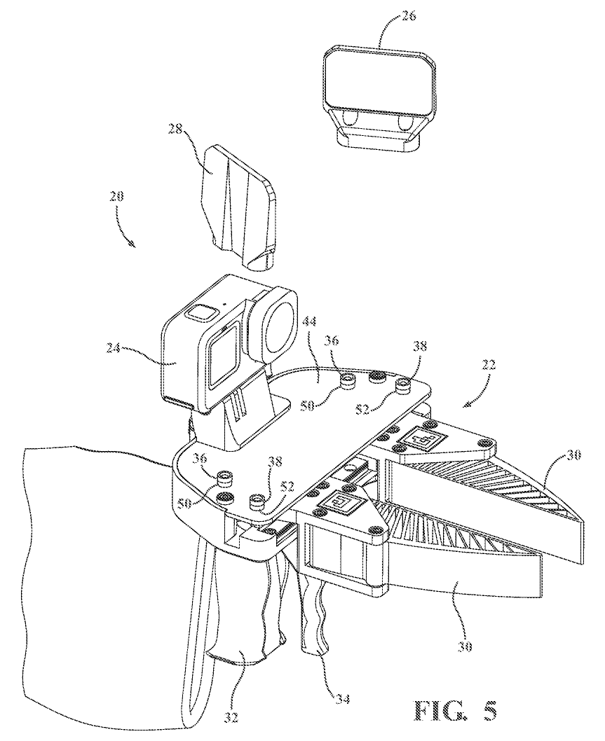

The mirrors 26, 28 are each movable from the first positions attached to the end effector 22 (as shown in FIGS. 1, 2, and 4) to second positions that are detached from the end effector 22 (as shown in FIG. 5). For example, application of sufficient force to one of the mirrors 26, 28 may overcome the magnetic coupling securing such mirror 26, 28 to the end effector 22 at the first position and moving such mirror 26, 26 to the second position. Detachment of the mirror 26, 28 may prevent damage to the mirror 26, 28, the end effector 22, and/or a coupling mechanism securing the mirror 26 to the end effector 22 when unintended force is applied to the mirror 26, 28, e.g., if an operator accidently drops the apparatus 20.

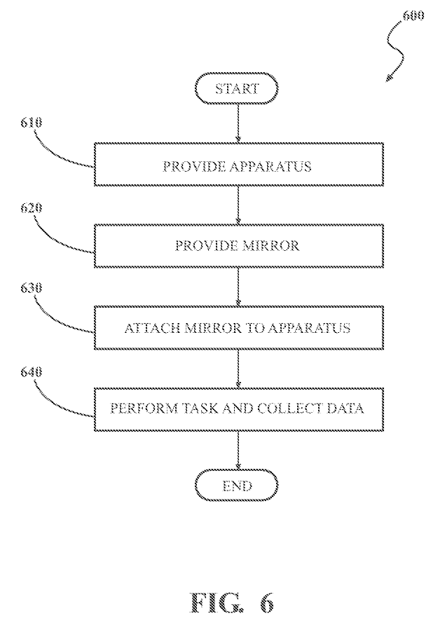

With reference to FIG. 6, a method 600 for collecting robot training data is illustrated. The method 600 begins at a block 610 where the apparatus 20 having the end effector 22 and the camera 24 attached to the end effector 22 are provided. At a block 620 at least one mirror 26, 28 is provided, e.g., in the second position. The block 620 may be performed before, after, or simultaneously with, the block 610.

Next at a block 630 the provided mirror 26, 28 is attached to the apparatus 20 via magnetic coupling. In other words, the provided mirror 26, 28 is moved from the second position to the first position. The provided mirror 26, 28 may be manually attached to the apparatus 20. For example, an operator may grasp the apparatus 20 and the provided mirror 26, 28 in the second position, and the move the provided mirror 26, 28 from the second positon to the first position by hand.

Attaching the mirror 26, 28 to the apparatus 20 may include magnetically coupling one or more magnets 36, 38 fixed to the gripper 22 with one or more magnets 40, 42 fixed to the mirror 26, 28. For example, the mirror 26, 28 may be placed on the top surface 44 with the one or more magnets 36, 38 fixed to the gripper 22 disposed in one or more recesses 46, 48 of the mirror 26, 28.

Next at a block 640, a task is performed with the apparatus 20 while collecting data with the camera 24. The task may be, for example, folding clothes, washing dishes, preparing food, and other object manipulation based tasks. To perform the task, the apparatus 20 may be manually manipulated by the operator, i.e., by hand. The data collected with the camera 24 while performing the task may be used for robot training. After the block 640 the method 600 may end.

The adjectives “first,” “second,” etc., are used throughout this document as identifiers and are not intended to signify importance or order. While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An apparatus for collecting robot training data, the apparatus comprising:
an end effector;
a camera supported by the end effector; and
a mirror movable from a first position that is attached to the end effector to a second position that is detached from the end effector, the mirror in the first position being magnetically coupled to the end effector and oriented such that light reflected by the mirror is directed toward the camera.

2. The apparatus of claim 1, further comprising a second mirror movable from a first position that is attached to the end effector to a second position that is detached from the end effector, the second mirror in the first position being magnetically coupled to the end effector and oriented such that light reflected by the second mirror is directed toward the camera.

3. The apparatus of claim 2, wherein the mirror and second mirror at the first positions are orientated to provide stereoscopic views to the camera.

4. The apparatus of claim 1, further comprising a magnet fixed to the mirror.

5. The apparatus of claim 1, further comprising a magnet fixed to the end effector.

6. The apparatus of claim 1, further comprising a first magnet fixed to the mirror and a second magnet fixed to the end effector, the first magnet and the second magnet magnetically coupled to each other in the first position.

7. The apparatus of claim 1, further comprising a first magnet and a second magnet, the first magnet and the second magnet spaced from each other along a top surface of the end effector.

8. The apparatus of claim 7, wherein the first magnet and the second magnet are fixed to the end effector.

9. The apparatus of claim 1, wherein the end effector has a protrusion and the mirror has a recess, the protrusion disposed in the recess in the first position.

10. The apparatus of claim 9, wherein the end effector has a second protrusion and the mirror has a second recess, the second protrusion disposed in the second recess in the first position.

11. The apparatus of claim 9, further comprising a magnet disposed in the recess in the first position.

12. The apparatus of claim 11, further comprising a second magnet disposed in the recess and magnetically coupled to the magnet in the first position.

13. The apparatus of claim 12, wherein the magnet is fixed to the mirror and the second magnet is fixed to the end effector.

14. The apparatus of claim 13, wherein the second magnet is fixed at a distal end of the protrusion.

15. The apparatus of claim 14, wherein the protrusion extends along an axis and the magnet is radially spaced from second magnet relative to the axis.

16. The apparatus of claim 1, wherein the end effector has fingers movable from an open positon to a closed position.

17. The apparatus of claim 16, wherein the end effector has a handle with a trigger configured to actuate the fingers from the open position to the closed position.

18. A method for collecting robot training data, the method comprising:
providing an apparatus having an end effector and a camera;
providing a mirror;
attaching the mirror to the apparatus via magnetic coupling; and
performing a task with the apparatus while collecting data with the camera.

19. The method of claim 18, wherein the apparatus includes a first magnet and the mirror includes a second magnet, and wherein attaching the mirror to the apparatus includes magnetically coupling the first magnet with the second magnet.

20. The method of claim 18, wherein performing the task with the apparatus includes manually manipulating the apparatus.
